(19) United States
(12) Patent Application Publication
(10) Pub. No.: US 2018/0239064 A1
(43) Pub. Date: Aug. 23, 2018

(54) LENS COMPONENT OF A RAIN SENSOR, MODULAR SYSTEM, METHOD, AND TOOL FOR PRODUCING THE SAME

(71) Applicant: TRW AUTOMOTIVE ELECTRONICS AND COMPONENTS GMBH, Radolfzell (DE)

(72) Inventor: Ulrich Backes, Radolfzell (DE)

(21) Appl. No.: 15/760,344

(22) PCT Filed: Oct. 7, 2016
(86) PCT No.: PCT/EP2016/073984

§ 371 Date: Mar. 15, 2018

(30) Foreign Application Priority Data
Oct. 9, 2015 (DE) 10 2015 117 266.6

(51) Int. Cl. G02B 3/08; B29D 11/00; B60S 1/08; G01N 21/552

(52) U.S. Cl. CPC G02B 3/08; B29D 11/00269; B60S 1/0881; G01N 21/552; B60S 1/0844; B60S 1/0837

(57) ABSTRACT

A lens component of an optical rain sensor (10) has an emitter lens (16) configured as a Fresnel lens and a receiver lens (18) configured as a Fresnel lens, each of which, in a top view, has a rectangular contour with first edges and second edges extending at right angles thereto, the center (M_{S}) of the emitter lens (16) and/or the center (M_{E}) of the receiver lens (18) being arranged off-center with respect to the side length of at least one of the edges, and the emitter lens (16) and the receiver lens (18) being arranged side by side. The lens component (12) is manufactured in a negative molding process in which first and second mold inserts are arranged side by side, each of which having a Fresnel lens mold, the first and second mold inserts each being selectively arranged in a manner rotated through 0° or through 180°, and the mold inserts arranged in this way forming a negative mold for the emitter lens (16) and the receiver lens (18) of the lens component (12) during the negative molding process. This provides a modular system for manufacturing optical rain sensors (10), having lens components (12) in a plurality of different configurations which differ from each other in regard to the distance of the centers (M_{S}, M_{E}) of the emitter lens (16) and the receiver lens (18). For manufacturing the lens component (12), the mold inserts are arranged side by side, each in a manner selectively rotated through 0° or through 180°, and are negative-molded using a suitable plastic material. This is performed in a tool for manufacturing a lens component (12), which includes a mount into which the mold inserts can be placed next to each other along the second edge, the first and/or the second mold insert each being adapted to be inserted into the mount in a manner rotated through 0° or through 180°.

### RELATED APPLICATIONS

This application corresponds to PCT/EP2016/073984, filed Oct. 7, 2018, which claims the benefit of German Application No. 10 2015 117 266.6, filed Oct. 9, 2015, the subject matter of which are incorporated herein by reference in their entirety.

### BACKGROUND OF THE INVENTION

The present invention relates to a lens component of a rain sensor and to a modular system, a method and a tool for manufacturing a rain sensor.

One known design of optical rain sensors is based on light being coupled into a windshield via a first lens, being totally reflected therein, and coupled out again via a second lens. Depending on the degree of wetting of the windshield, the proportion of the light that is totally reflected varies and, thus, the proportion of the light reflected from the receiver lens to a light-sensitive receiver also varies.

A drawback with this design is that the optical path is dependent on the thickness of the particular windshield used and, therefore, the optimum distance between the emitter lens and the receiver lens also depends on this windshield thickness. Since the emitter and receiver lenses are usually combined on one single, integral component part, an adjustment to respective different windshield thicknesses requires different lens components, something which entails high tooling costs.

### SUMMARY OF THE INVENTION

The object of the present invention is to reduce the costs for manufacturing a rain sensor and to make production more flexible.

According to a first aspect of the present invention, this object is achieved by a lens component of an optical rain sensor which has an emitter lens configured as a Fresnel lens and a receiver lens configured as a Fresnel lens, each of which, in a top view, has a rectangular contour with first edges and second edges extending at right angles thereto. The center of the emitter lens and/or of the receiver lens is located off-center with respect to the side length of at least one of the edges, and the emitter lens and the receiver lens are arranged side by side. The lens component is manufactured in a negative molding process in which a first mold insert and a second mold insert are arranged side by side, each of which having a Fresnel lens mold. The first and second mold inserts are each selectively arranged in a manner rotated through 0° or through 180°, and the mold inserts arranged in this way form a negative mold for the emitter lens and the receiver lens of the lens component during the negative molding process.

Owing to the off-center arrangement of the center of the emitter lens and/or the receiver lens, the different combinations that are feasible and are obtained by rotating the individual mold inserts result in a number of different configurations for the lens component in which the centers of the emitter lens and the receiver lens have different distances in the finished lens component.

In this way, more particularly only one tool and a minimum of two different mold inserts are required for manufacturing a plurality of, in particular four, lens components having different distances of the centers of the emitter lens and the receiver lens, which already cover a large spectrum of different windshield thicknesses.

The term “off-center” in this context means that, as viewed along an edge direction, the center of the respective Fresnel lens has different distances from the edges, perpendicular to this edge direction, of the rectangular contour of the respective lens.

The negative molding may be performed by injection molding, for example; a suitable plastic material that is transparent in the light wavelength range used is employed for the lens component. The lens component may be made completely from this plastic material, but it is also possible to provide, e.g., opaque areas made from a different plastic material.

Each of the Fresnel lens molds of the mold inserts is designed such that it, separately, constitutes a negative mold of an operative Fresnel lens. In view of the properties of Fresnel lenses, this does not require that all of the individual circles constituting the Fresnel lens are circumferentially completely formed on the mold insert or on the lens. For example, the outer circles may be cut off where the rectangular contour of the respective lens or the respective mold insert ends. Since Fresnel lenses exhibit the same beam deflection substantially at any point, a sufficiently good deflection of the incident or emergent light beam will result even in case of an off-center arrangement of the lens center in a Fresnel lens and in a rectangular contour with parts of a basically circular lens cut off.

Preferably, the emitter lens and the receiver lens and, accordingly, the first and second mold inserts are placed next to each other such that either their first or their second edges run parallel. In particular, the mold inserts and, thus, also the emitter lens and the receiver lens lie immediately side by side and touch each other. The emitter lens and the receiver lens are therefore preferably directly adjacent to each other in the lens component.

Preferably, the centers of the emitter lens and of the receiver lens lie on a straight line which runs parallel to one of the edge directions. In this case, the light emitter and the light receiver each need to be displaced only in one dimension on the associated printed circuit board in order to adjust the printed circuit board to the particular configuration of the lens component.

In one preferred embodiment, the emitter lens and the receiver lens in the lens component are arranged side by side in the direction of the second edges, and the side lengths of the first edges are the same for the emitter lens and the receiver lens while the side lengths of the second edges of the emitter lens and the receiver lens are different. When placing the emitter lens and the receiver lens in line, this results in a compact, rectangular shape for that area of the lens component that accounts for the emitter lens and the receiver lens, which is identical for all feasible configurations of the lens component, irrespective of the rotation of the emitter lens and/or the receiver lens through 0° or through 180°.

To obtain a linear grading of the distances of the centers of the emitter lens and the receiver lens, the side lengths of the second edges may be selected as follows, for example:

a₂=a₁d_{off}

b₂=b₁+2d_{off}

a₁+b₁=dₘᵢₙ

a₂+b₁=dₘᵢₙ+d_{off}

a₁+b₂=dₘᵢₙ+2_{doff}

a₂+b₂=dₘᵢₙ+3d_{off},

wherein a₁, a₂ are the distances between the center of the Fresnel lens mold of the first mold insert and the first edges along the second edges, and a₁<a₂, and b₁, b₂ are the distances between the center of the Fresnel lens mold of the second mold insert and the first edges along the second edges, and b₁<b₂.

The distances as specified for the mold inserts here are identical with the distances in the finished emitter and receiver lenses.

To improve the effect of the Fresnel lenses, at those places where the rectangular shape does not permit complete circles of the Fresnel lens the emitter lens and the receiver lens are preferably filled with circular arc sections that correspond to the respective sections of the Fresnel lens, up to the edges of the rectangular contour. In other words, the rectangular contour is a cutout from a larger Fresnel lens in which the sections extending beyond the rectangular contour are cut away. This is, of course, true in an analogous manner for the Fresnel lens molds of the mold inserts, from the negative molding of which the emitter lens and the receiver lens are produced.

While two Fresnel lenses arranged side by side, each having a rectangular contour, are provided on one side of the lens component in that area which contains the emitter lens and the receiver lens, a continuous, periodic prism structure is preferably arranged on a second, opposite side of the lens component.

This prism structure is independent of the configuration, as used in the specific lens component, of the combination of the emitter lens and the receiver lens and consists, for example, of parallel, roof-shaped prisms which run parallel to the first edges of the emitter lens and the receiver lens and, accordingly, to the first edges of the mold inserts.

The lens component may in particular be generally formed as a rectangular plate, but may also include further geometric structures that are, however, not relevant to the invention and will therefore not be described here.

A lens component of this type may be installed into an optical rain sensor, so that the invention also relates to a rain sensor comprising a respective lens component.

According to a second aspect of the present invention, the above-mentioned object is also achieved by a modular system for the manufacture of optical rain sensors. As already described above, the lens component can be realized in a plurality of different configurations, the lens component always having an emitter lens configured as a Fresnel lens and a receiver lens configured as a Fresnel lens, each of which, in a top view, has a rectangular contour with first edges and second edges extending at right angles thereto. In the different configurations, the emitter lens and the receiver lens are each placed next to each other in a manner rotated through 0° or through 180° in the direction of one of their edges. In this way, the different configurations differ from one another in regard to the distance of the centers of the emitter lens and the receiver lens. For a given windshield thickness, the respective lens component having the suitable configuration is then selected.

Depending on the design of the emitter lens and the receiver lens, in this way a plurality of different configurations having different center distances can be realized using two different rectangular contours. In particular, rectangular contours having an identical side length of the first edges and different side lengths of the second edges for the emitter end receiver lenses allow up to four different distances of the centers to be realized if the centers are arranged centrally with respect to the first edges.

The lens component is preferably formed in one piece in each of the configurations. As has already been described above, to this end in particular first and second mold inserts may be provided, the mold inserts, in a top view, each having a rectangular contour with first edges and second edges extending at right angles thereto and each including a Fresnel lens mold. To manufacture the different configurations of the lens component, the mold inserts are placed next to each other in the direction of one of their edges, each in a manner rotated through 0° or through 180°, and are subsequently negative-molded.

In addition, according to a third aspect of the invention, the object indicated above is achieved by a method of manufacturing a lens component of an optical rain sensor, the lens component having an emitter lens configured as a Fresnel lens and a receiver lens configured as a Fresnel lens, each of which, in a top view, has a rectangular contour with first edges and second edges extending at right angles thereto; in this method, first and second mold inserts which are rectangular in a top view and which each include a Fresnel lens mold are arranged side by side and are negative-molded using a suitable plastic material. The center of the Fresnel lens mold of the first and/or second mold insert is arranged off-center with respect to the side length of the first and/or second edges of the rectangular contour. The first mold insert and the second mold insert are each selectively arranged in a manner rotated through 0° or through 180°, which results in different distances of the centers of the emitter lens and the receiver lens in the lens component.

The first mold insert can generate either the emitter lens or the receiver lens, and the second mold insert then correspondingly generates the receiver lens or the emitter lens. Since the optical path through the lens component is preferably symmetrical with respect to the centers of the two lenses, the positions of the emitter and receiver lenses may each be exchanged without difficulty.

As already described above, the distance of the centers of the emitter lens and the receiver lens is equal to the distance of the centers of the Fresnel lens molds of the first mold insert and the second mold insert after they are arranged next to each other.

The arrangement of the mold inserts is preferably selected in dependence on a selected windshield thickness for which the particular rain sensor is intended.

In a preferred embodiment, the edge lengths of the mold inserts are equal along the first edges, and the centers of the Fresnel lens molds are arranged centrally with respect to the side lengths of the first edges. This always results in a rectangle having outer contours of equal length for all different configurations that are feasible of the mold inserts arranged side by side and the resulting lens component.

In the manufacture of the lens component, preferably the emitter lens and the receiver lens are produced on a first side, and a continuous, periodic prism structure is produced on a second, opposite side. The prism structure preferably has dimensions that are identical to those of the combination of the emitter lens and the receiver lens and, in a top view, is congruently superimposed thereon.

Advantageously, the negative molding process is an injection molding process in which the lens component is more particularly produced in one piece. The manufacture of the specific configuration of the lens component can be switched over quickly and without great effort by a simple rotation of one or both mold inserts.

To carry out the method described and, thus, to manufacture the above-described modular system of lens components, according to a fourth aspect of the invention use can be made of a tool for manufacturing a lens component of an optical rain sensor, having an emitter lens and a receiver lens which are each configured as a Fresnel lens. Provided in the tool are a first mold insert which is rectangular in a top view end a second mold insert which is rectangular in a top view, both the first and second mold inserts including a Fresnel lens mold. The first mold insert and the second mold insert each have first edges with a first side length and second edges with a second side length, the first side length of the two mold inserts in particular being equal. The center of the Fresnel lens mold in the first mold insert and/or in the second mold insert is arranged off-center at least with respect to the side lengths of the second edges. The tool has a mount provided therein into which the first mold insert and the second mold insert can be placed next to each other along the second edge, the first and/or the second mold insert each being adapted to be inserted into the mount in a manner rotated through 0° or through 180°.

The side lengths of the second edges of the two mold inserts are preferably different, in order that a larger number of different configurations of the lens component can be obtained, which differ in regard to the distances of the centers of the emitter lens and the receiver lens.

The relation already set forth above preferably applies to the distances of the centers of the Fresnel lens molds of the first mold insert and the second mold insert from the first edges of the mold inserts as viewed along the second edge.

The mount within the tool is advantageously of a rectangular shape, and the dimension of the side length of the first edge and the sum of the side lengths of the second edge of the two mold inserts then substantially correspond to the dimension of the mount. In this way, an adjustment of the positions of the mold inserts and a locating of the mold inserts within the tool may possibly be dispensed with.

### BRIEF DESCRIPTION OF THE DRAWINGS

The invention will now be described in greater detail below on the basis of an exemplary embodiment with reference to the accompanying drawings, in which:

FIGS. 1 and 2 show schematic illustrations of the mode of operation of a rain sensor according to the invention, with a lens component according to the invention in two configurations which are designed for different windshield thicknesses;

FIG. 3 shows a schematic perspective illustration of a lens component according to the invention, manufactured in accordance with a method according to the invention;

FIG. 4 shows a schematic illustration of mold inserts for an emitter lens and a receiver lens of a lens component according to the invention;

FIG. 5 shows different configurations of the mold inserts of FIG. 4, which at the same time also correspond to different configurations of the emitter lens and the receiver lens in the lens component according to the invention;

FIG. 6 shows a schematic perspective illustration of a tool according to the invention for manufacturing a lens component according to the invention; and

FIG. 7 shows a further illustration of the tool of FIG. 6.

### DESCRIPTION

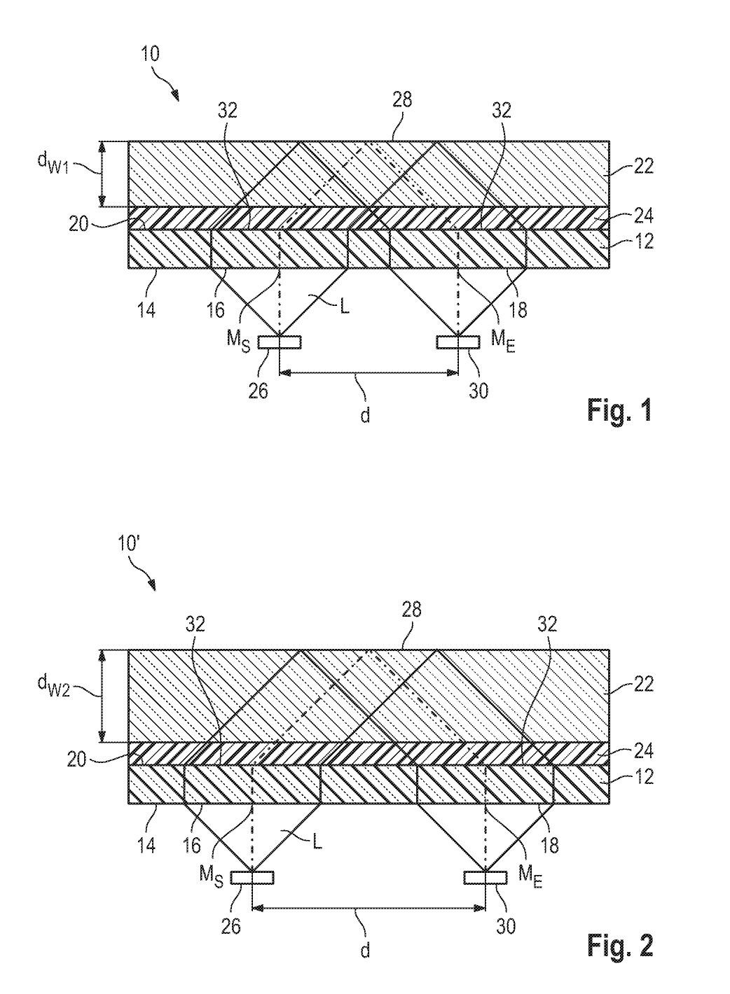

FIGS. 1 and 2 show a rain sensor 10 and a rain sensor 10′ in the installed state. One constituent part of the optical rain sensor 10, 10′ is a lens component 12 which carries an emitter lens 16 and a receiver lens 18 on the surface on a side 14. Both the emitter lens 16 and the receiver lens 16 are Fresnel lenses here and are formed as a structure in the surface of the side 14.

The entire lens component 12 may consist of a plastic material transparent to the light used, but transparent and opaque portions may also be provided.

The lens component 12 has a side 20 that is opposite to the side 14 and faces a pane 22, e.g. the windshield of a vehicle, and is oriented parallel thereto. A flexible coupling layer 24 made from a silicone, for example, is normally provided between the surface of the side 20 and the pane 22 and provides for a uniform optical transition between the lens component 12 and the pane 22.

The emitter lens 16 is illuminated with a bundle L of light rays which is emitted by e light emitter 26. When it passes the emitter lens 16, the bundle L of light rays turns into a parallel beam and is coupled into the pane 22 via the coupling layer 24, at an angle which leads to total reflection at a wetting-sensitive surface 28 of the pane 22, for example the outer side of the windshield. Following the total reflection within the pane 22, the bundle L of light rays is incident on the receiver lens 16 where it is focused again and directed to a light receiver 30.

When the surface 28 is wetted, the reflection behavior will change since the part of the bundle L of light rays that is reflected back is smaller, which can be evaluated at the light receiver 30.

The reflection behavior in the pane 22 is dependent on the thickness d_{w1}, d_{w2} of the pane, so that the pane thickness has an influence on the optimum distance between the emitter lens 16 and the receiver lens 18. Therefore, for a thicker pane the distance between the centers M_{S} and M_{E} of the emitter lens 16 and the receiver lens 18, respectively, needs to be adjusted since, as can be seen in the Figures, the necessary distance d increases as the pane thickness increases.

The emitter lens 16 and the receiver lens 18 are assigned arbitrarily in this example since, as can be seen in the Figures, the optical path in the rain sensor 10,10′ is symmetrical between the emitter lens 16 and the receiver lens 18. It would therefore also be possible to exchange the light emitter 26 and the light receiver 30, without changing the function of the rain sensor 10, 10′. Within the scope of the present application, the emitter lens 16 and the receiver lens 18 can therefore always be exchanged as regards their functions and positions.

For coupling the bundle L of light rays out of the lens component 12, a suitable structure is provided on the surface of the side 20, in this case a prism structure 32, to be described in more detail infra.

FIGS. 1 and 2 show two lens components 12 in accordance with a modular system that includes a number of lens components 12 in different configurations, each of which has a different distance d between the centers M_{S}, M_{E} of the emitter lens 16 and the receiver lens 18.

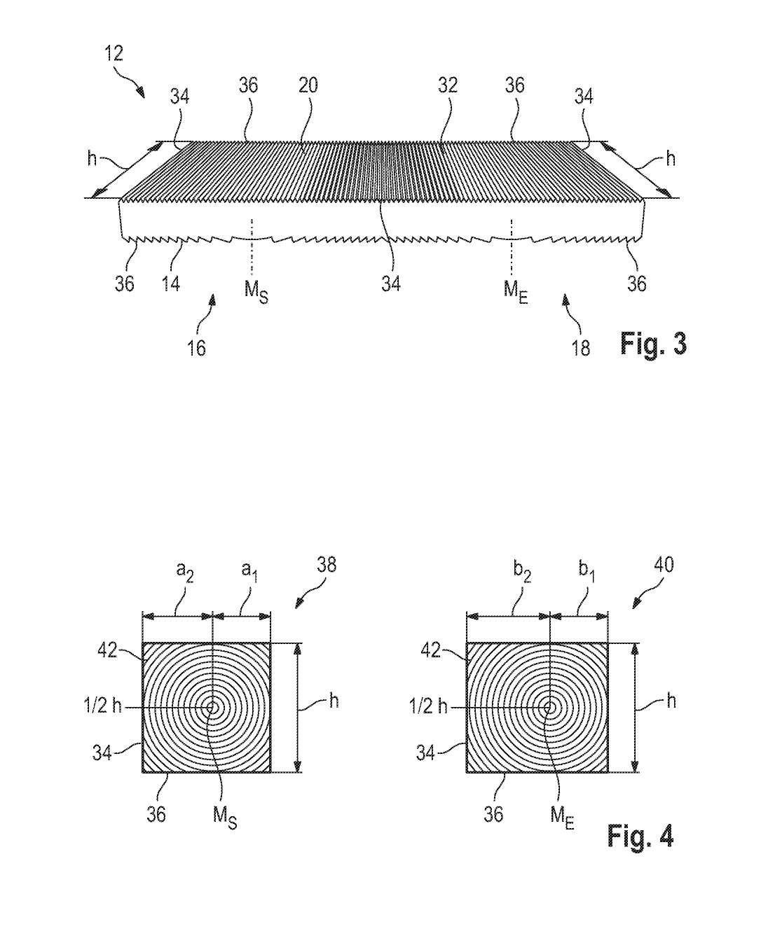

One feasible configuration of a lens component 12 is shown in FIG. 3. In each of these examples, only that region of the lens component 12 is illustrated which carries the emitter lens 16 and the receiver lens 18. The lens component 12 may include further sections and further geometric structures, which, however, are not relevant to the invention and are therefore not illustrated.

In a top view, both the emitter lens 16 and the receiver lens 18 have a rectangular contour, with two parallel first edges 34 and two parallel second edges 36 which are perpendicular to the first edges 34. In this case, the emitter lens 16 and the receiver lens 18 are arranged such that their first edges 34 are directly and immediately adjacent to each other.

In this example, the side lengths h of the first edges 34 are equal for each of the emitter lens 16 and the receiver lens 18. The side lengths of the second edges 36 may be selected to be equal for the emitter lens 16 and the receiver lens 18, but in this example they are different.

The lens component 12 is formed in one piece, i.e. the emitter lens 16 and the receiver lens 18 are integrally and continuously connected with each other at the interior, adjacent first edges 34 in FIG. 3.

The lens component 12 is manufactured by using a first mold insert 38 and a second mold insert 40 (see FIGS. 4, 6 and 7), which each carry a Fresnel lens mold 42 which represents a negative of an operative Fresnel lens, in this case the emitter lens 16 and, respectively, the receiver lens 18. In this example, the first mold insert 38 is assigned to the emitter lens 16 and the second mold insert 40 is assigned to the receiver lens 18; this is selected arbitrarily and may also be realized the other way round at a skilled person's discretion.

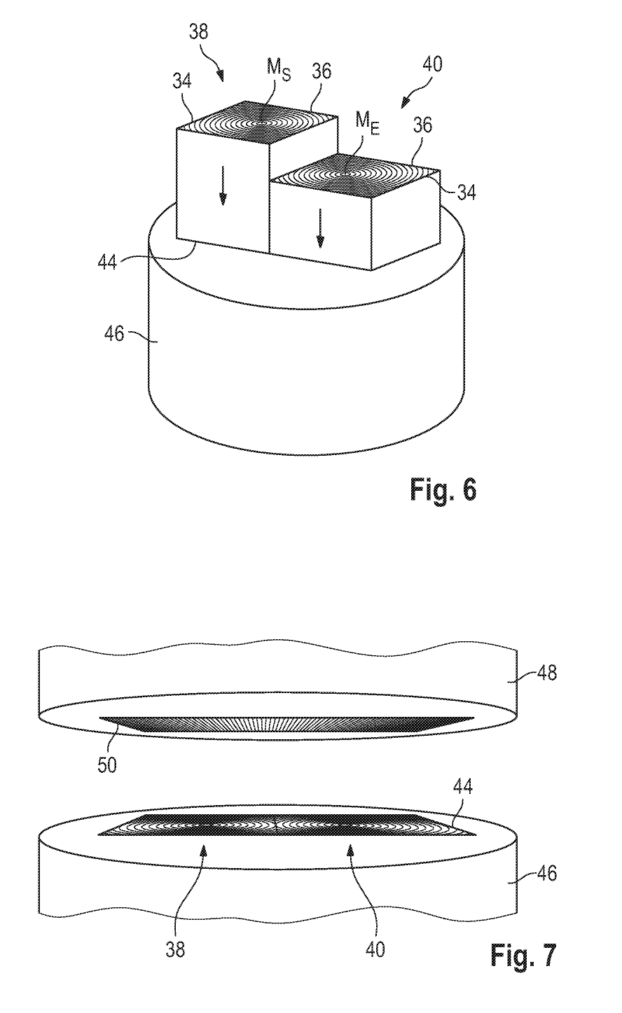

The two mold inserts 38, 40 are placed next to each other by their first edges 34 and, in this example, are brought into direct contact with each other and are inserted into a mount 44 in a tool part 46 (see FIGS. 6 and 7), the mount having the dimensions of the side length h of the first edge 34 and of the sum of the side lengths of the second edges 36 here. The mold inserts 38, 40 placed side by side can thus be inserted into the mount 44 with an exact fit.

The lens component 12 is then manufactured by means of the tool 46 in a negative molding process, for example an injection molding process.

Each of the Fresnel lens molds 42 of the mold inserts 38, 40 is an exact negative mold of the later emitter lens 16 and receiver lens 18. The rectangular outer contour of the mold inserts 38, 40 obviously causes the Fresnel lens mold 42 to be cut off at the edges, i.e. the outer circles of the Fresnel lens mold 42 that are actually concentric about the center M_{S}, M_{E} to be incomplete. However, because of the properties of Fresnel lenses, this is not detrimental to the function of the lenses.

The positions of the centers M_{S}, M_{E} of the emitter lens 16 and receiver lens 18 are uniquely predefined by the positions of the centers M_{S}, M_{E} of the mold inserts 38, 40. The molding process merely creates a mirror-inverted image.

In this example, both the center M_{S} of the emitter lens 16 and the center M_{E} of the receiver lens 18 are arranged off-center with respect to the second edge 38, that is, with respect to the distance from the two first edges 34. A central position is, however, selected with respect to the first edge 34, that is, with respect to the distance from the two second edges 36, so that the distance from both first edges is in each case ½ h, with the first edges 34 having a side length h.

Depending on the orientation in which the mold inserts 38, 40 are placed next to each other along the second edges 36, different distances of the centers M_{S}, M_{E} are obtained. In principle, both mold inserts 33, 40 can be oriented in a manner rotated through 0° (that is, without being rotated) or through 180°.

A suitable selection of the side lengths of the second edges 36 allows a linear gradation of the distance of the centers M_{S}, M_{E} of the emitter lens 16 and the receiver lens 18 to be generated in the lens component 12.

The distances of the center M_{S} of the emitter lens 16 (and of the Fresnel lens mold 42 of the first mold insert 38) from the first sides 34 along the second edge 36 are denoted by a₁, a₂ here, while the distances of the center of the receiver lens 18 (and of the Fresnel lens mold 42 of the second mold insert 40) from the first edges 34 are denoted by b₁, b₂. In this example, the second mold insert 40 is wider than the first mold insert 38 and, thus, the receiver lens 16 is wider than the emitter lens 16, which means that the following applies to the second side lengths: a₁+a₂<b₁+b₂.

When the side lengths of the second edges 36 and the respective offset in relation to the center of the side length are selected as follows:

a₂=a₁+d_{off}

b₂=b₁+2d_{off}

a₁+b₁=dₘᵢₙ

a₂+b₁=dₘᵢₙ+d_{off}

a₁+b₂=dₘᵢₙ+2d_{off}

a₂+b₂=dₘᵢₙ3d_{off},

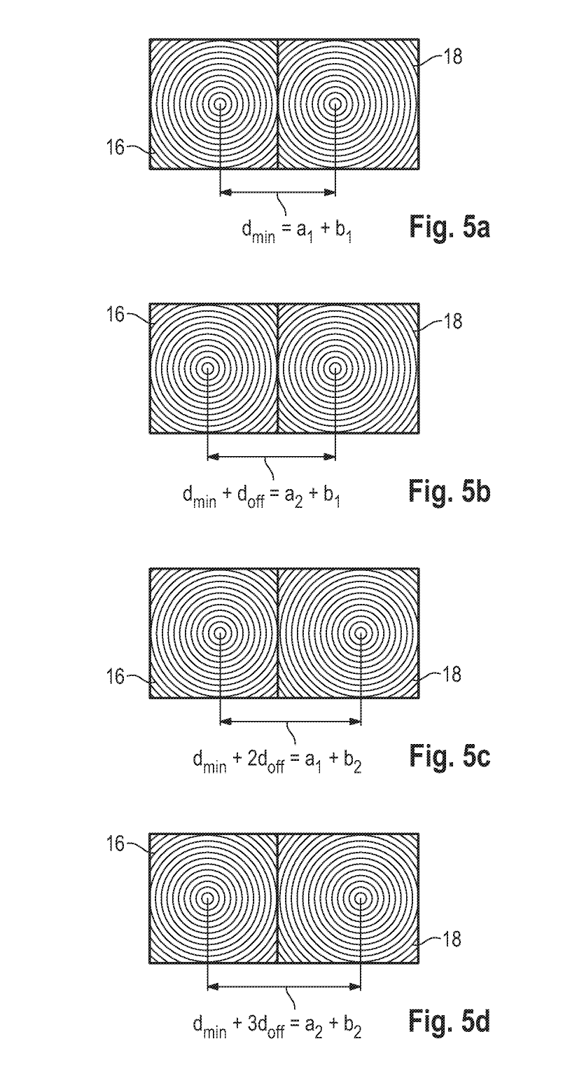

the four feasible configurations, shown in FIG. 5, of the modular system for the lens component 12 are obtained, depending on whether the first mold insert 38 and the second mold insert 40 are inserted in the mount 44 in a manner rotated through 0° or through 180°.

FIG. 5a shows the configuration having the minimum distance dₘᵢₙ=a₁+b₁. In this case, the first mold insert 38 is inserted in the position as shown in FIG. 4, whereas the second mold insert 40 has been rotated through 180° compared with the position shown in FIG. 4 (the orientation of the mold inserts is indicated by the position of the reference numbers in FIG. 5).

FIG. 5b shows the case in which both the first mold insert 38 and the second mold insert 40 are used after being rotated through 180°; here, the distance between the centers M_{S}, M_{E} is dₘᵢₙ+d_{off}=a₂+b₁.

FIG. 5c shows the case in which both the first mold insert 38 and the second mold insert 40 are placed next to each other in a state rotated through 0°. Here, the distance between the centers M_{S}, M_{E} is dₘᵢₙ+2d_{off}=a₁+b₂.

FIG. 5d shows the last configuration, in which the first mold insert 38 has been rotated through 180° and the second mold insert 40 has been rotated through 0°, that is, it is in the position shown in FIG. 4, before they are placed next to each other. Here, the distance between the centers M_{S}, M_{E} equals dₘᵢₙ+3d_{off}=a₂+b₂.

In this way, one single tool part 46 and only two mold inserts 38, 40 are sufficient tor producing four configurations of a lens component 12 having different distances of the centers M_{S}, M_{E} of the emitter lens 16 and the receiver lens 18, merely by turning one or both of the mold inserts 38, 40 in the mount 44 of the tool 46. This results in a modular system of four different lens components 12, which are adapted to different pane thicknesses, without the production of a respective separate tool being required.

In this example, the prism structure 32 on the surface of the side 20 of the lens component 12 is also manufactured in the same work step as the negative molding of the emitter lens 16 and the receiver lens 18 from the mold inserts 33, 40. To this end, a second tool part 43 is provided (see FIG. 7), which here also includes a mold insert 50 in a corresponding mount, with the mold insert 50 carrying the negative mold of the prism structure 32. In the region in which the emitter lens 16 and the receiver lens 18 are arranged, the integrally produced lens component 12 thus includes the congruently overlying prism structure 32 on the opposite side 20.

Instead of the geometries as described here for the side lengths of the first edges 34 and the second edges 38 and the apportionment of the distances of the centers M_{S}, M_{E} from the edges 34, 36, any other desired geometries could, of course, also be employed.

A larger number of configurations having different distances of the centers M_{S}, M_{E} could be obtained, for example, by performing an offset with respect to the second edges 36 as well, i.e. along the first edge 34. This, however, would involve an additional expenditure in the adaptation of the printed circuit board carrying the light emitter 28 and the light receiver 30 since in this case the connecting line between the centers M_{S}, M_{E} of the emitter lens 16 and the receiver lens 18 no longer lies on a straight line parallel to the second edge 36.

1. A lens component of an optical rain sensor (10, 10′), comprising an emitter lens (16) configured as a Fresnel lens and a receiver lens (18) configured as a Fresnel lens, each of which, in a top view, has a rectangular contour with first edges (34) and second edges (36) extending at right angles thereto,
the center (M_{S}) of the emitter lens (16) and/or the center (M_{E}) of the receiver lens (18) being arranged off-center with respect to the side length of at least one of the edges (34, 36), and the emitter lens (16) and the receiver lens (18) being arranged side by side,
the lens component (12) being manufactured in a negative molding process in which a first mold insert (38) and a second mold insert (40) are arranged side by side, each of which having a Fresnel lens mold (42), the first and second mold inserts (38, 40) each being selectively arranged in a manner rotated through 0°or through 180°, and the mold inserts (38, 40) arranged in this way forming a negative mold for the emitter lens (16) and the receiver lens (18) of the lens component (12) during the negative molding process.

2. The lens component according to claim 1, wherein the emitter lens (16) and the receiver lens (18) are directly adjacent to each other.

3. The lens component according to claim 1, wherein the centers (M_{S}, M_{E}) of the emitter lens (16) and the receiver lens (18) lie on a straight line which runs parallel to one of the edges (34, 36).

4. The lens component according to claim 1, wherein the emitter lens (16) and the receiver lens (18) are arranged side by side in the direction of the second edges (36), and in that the side lengths (h) of the first edges (34) are the same for the emitter lens (16) and the receiver lens (18) and the side lengths of the second edges (36) of the emitter lens (16) and the receiver lens (18) are different.

5. The lens component according to claim 1, wherein the following applies to the distances of the centers (M_{S}, M_{E}) of the Fresnel lens molds (42) of the first mold insert (38) and of the second mold insert (40) from the first edges (34) of the mold inserts (38, 40) along the second edge (36);
a₂=a₁+d_{off}
b₂=b₁+2d_{off}
a₁+b₁=dₘᵢₙ
a₂+b₁=dₘᵢₙ+d_{off}
a₁+b₂=dₘᵢₙ+2d_{off}
a₂+b₂=dₘᵢₙ+3d_{off},
wherein a₁, a₂ are the distances between the center (M_{S}) of the Fresnel lens mold (42) of the first mold insert (38) and the first edges (34) along the second edges (36), and a₁<a₂, and
b₁, b₂ are the distances between the center (M_{E}) of the Fresnel lens mold (42) of the second mold insert (40) and the first edges (34) along the second edges (36), and b₁<b₂.

6. The lens component according to claim 1, wherein the emitter lens (16) and the receiver lens (18) are filled with circular arc sections up to the edges (34, 36) of the rectangular contour at those places where the rectangular shape does not permit complete circles of the Fresnel lens.

7. The lens component according to claim 1, wherein the emitter lens (16) and the receiver lens (18) are arranged on a first side (14) and a continuous, periodic prism structure (32) is arranged on a second, opposite side (20).

8. A rain sensor comprising a lens component (12) according to claim 1.

9. A modular system for manufacturing optical rain sensors (10, 10′), comprising a lens component (12) in a plurality of different configurations, wherein the lens component (12) has an emitter lens (16) configured as a Fresnel lens and a receiver lens (18) configured as a Fresnel lens, each of which, in a top view, has a rectangular contour with first edges (34) and second edges (36) extending at right angles thereto, and wherein, in the different configurations, the emitter lens (16) and the receiver lens (18) are each placed next to each other in a manner rotated through 0° or through 180° in the direction of one of their edges (34, 36), so that the different configurations differ from one another in regard to the distance of the centers (M_{S}, M_{E}) of the emitter lens (16) and the receiver lens (18).

10. The modular system according to claim 9, wherein the lens component (12) is formed in one piece in each case, in particular by first and second mold inserts (38, 40) being provided, each of which, in a top view, has a rectangular contour with first edges (34) and second edges (36) extending at right angles thereto and each of which includes a Fresnel lens mold, wherein the mold inserts (38, 40) are placed next to each other in the direction of one of their edges (34, 36), each in a manner rotated through 0° or through 180°, and are negative-molded to manufacture the different configurations of the lens component (12).

11. A method of manufacturing a lens component (12) of an optical rain sensor (10, 10′), comprising an emitter lens (16) configured as a Fresnel lens and a receiver lens (18) configured as a Fresnel lens, each of which, in a top view, has a rectangular contour with first edges (34) and second edges (36) extending at right angles thereto, wherein:
first and second mold inserts (38, 40) which are rectangular in a top view and which each include a Fresnel lens mold are arranged side by side and are negative-molded using a suitable plastic material,
the center (M_{S}, M_{E}) of the Fresnel lens mold of the first and/or the second mold insert (38, 40) being arranged off-center with respect to the side length of the first and/or the second edges (34, 36) of the rectangular contour,
and the first mold insert (38) and the second mold insert (40) are each selectively arranged in a manner rotated through 0° or through 180°, which results in different distances of the centers (M_{S}, M_{E}) of the emitter lens (16) and the receiver lens (18) in the lens component (12).

12. The method according to claim 11, wherein the arrangement of the mold inserts (38, 40) is selected in dependence on a selected windshield thickness (d_{w1}, d_{w2}) for which the rain sensor (10, 10′) is intended.

13. The method according to claim 11, wherein the side lengths (h) of the mold inserts (38, 40) are equal along the first edges (34) and the centers (M_{S}, M_{E}) of the Fresnel lens melds (42) are arranged centrally with respect to the side lengths (h) of the first edges (34).

14. The method according to claim 11, wherein the lens component (12) includes the emitter lens (16) and the receiver lens (18) on a first side (14) and in that a continuous, periodic prism structure (32) is generated on a second, opposite side (20) when the lens component (12) is produced.

15. The method according to claim 11, wherein the negative molding process is an injection molding process.

16. A tool for manufacturing a lens component (12) of an optical rain sensor (10, 10′), having an emitter lens (16) and a receiver lens (18) which are each configured as a Fresnel lens,
a first mold insert (38) being provided which is rectangular in a top view and a second mold insert (40) being provided which is rectangular in a top view, and both the first and second mold inserts (38, 40) including a Fresnel lens mold (42),
and the first mold insert (38) and the second mold insert (40) each having first edges (34) with a first side length (h) and second edges (36) with a second side length, the first side lengths (h) of the two mold inserts (38, 40) in particular being equal,
the centers (M_{S}, M_{E}) of the Fresnel lens mold (42) in the first mold insert (38) and in the second mold insert (40) being arranged off-center at least with respect to the side lengths of the second edges (36), and
a mount (44) being provided into which the first mold insert (38) and the second mold insert (40) can be placed next to each other along the second edge (36), the first and/or the second mold insert (38, 40) each being adapted to be inserted into the mount (44) in a manner rotated through 0° or through 180°.

17. The tool according to claim 16, wherein the side lengths of the second edges (36) of the two mold inserts (38, 40) are different.

18. The tool according to claim 17, wherein the following applies to the distances of the centers (M_{S}, M_{E}) of the Fresnel lens molds (42) of the first mold insert (38) and of the second mold insert (40) from the first edges (34) along the second edge (36):
a₂=a₁+d_{off}
b₂=b₁+2d_{off}
a₁+b₁=dₘᵢₙ
a₂+b₁=dₘᵢₙ+d_{off}
a₁+b₂=dₘᵢₙ+2d_{off}
a₂+b₂=dₘᵢₙ+3d_{off},
wherein a₁, a₂ are the distances between the center (M_{S}) of the Fresnel lens mold (42) of the first mold insert (38) and the first edges (34) along the second edges (38), and a₁<a₂, and
b₁, b₂ are the distances between the center (M_{E}) of the Fresnel lens mold (42) of the second mold insert (40) and the first edges (34) along the second edges (36), and b₁<b₂.

19. The tool according to claim 16, wherein the mount (44) is rectangular and has the dimension of the side length (h) of the first edge (34) and the sum of the side lengths of the second edges (36) of the two mold inserts (38, 40).
